(19) United States
(12) Patent Application Publication
(10) Pub. No.: US 2024/0344354 A1
(43) Pub. Date: Oct. 17, 2024

(54) CONTAINER DOOR ENGAGEMENT DEVICE

(71) Applicant: Stephanie Smith, Toronto (CA)

(72) Inventor: Stephanie Smith, Toronto (CA)

(21) Appl. No.: 18/300,377

(22) Filed: Apr. 13, 2023

(51) Int. Cl. E05B 1/00

(52) U.S. Cl. CPC E05B 1/0053

(57) ABSTRACT

A container door engagement device that is configured to be operably coupled to a handle of a latch operating the door of the container wherein the device of the invention transfers the leverage point for opening and/or closing the door to be adjacent a user's torso area. The invention includes a shaft member wherein the shaft member includes a first end and a second end. The shaft member has secured to the first end a latch engagement member which is configured to be operably coupled to a handle of a latch on the doors of the container. Secured to the second end of the shaft member is a handle member wherein the handle member is configured to be generally parallel with the handle of the latch. The shaft member includes three contiguously formed sections so as to place the handle member away from the doors and adjacent a user's torso.

### FIELD OF THE INVENTION

The present invention relates generally to hand tools, more specifically but not by way of limitation, a tool configured to assist a user open and/or close a shipping container door wherein the tool transfers the leverage point for the user so as to inhibit injury and more efficiently open/close the door to a trailer or container.

### BACKGROUND

As is known in the art, shipping containers and trailers are employed to transport objects in bulk. Millions of shipping containers and trailers are in use on a daily basis in North America and these containers and trailers are being loaded and unloaded by workers at various facilities. Both shipping containers and trailers are equipped with swing style doors that provide full access to the interior volumes thereof. These doors are operated with a rotatable latch that is operably coupled to an upper cam and lower cam wherein the cam ends are configured to engage a keeper so as to maintain the door in a closed position.

As workers engage the latch on the doors of the containers and trailers they must utilize a moderate amount of force to provide movement of the latch in order to open or close the door. These trailers and containers can sometimes be in a position wherein the latch is at a less than optimum height with respect to the individual trying to open the doors. Most often the latch can be at or above shoulder level which can cause injuries to the individual during either opening or closing the doors via operation of the latch.

Accordingly, there is a need for a device that can be operably coupled to a latch on a door of a trailer or shipping container wherein the present invention transfers the leverage point to be adjacent the torso of the user in order to provide an improved ability to open/close the doors.

### SUMMARY OF THE INVENTION

It is the object of the present invention to provide a container door engagement device configured to operably couple to a latch on a container door wherein the present invention includes a shaft member.

Another object of the present invention is to provide a tool configured to be operably coupled to a latch on a container door wherein the shaft member includes a first end and a second end.

A further object of the present invention is to provide a container door engagement device configured to operably couple to a latch on a container door wherein the shaft member includes a latch engagement member on the first end thereof.

Yet a further object of the present invention is to provide a tool configured to be operably coupled to a latch on a container door that further includes a handle member secured to the second end of the shaft member.

Still another object of the present invention is to provide a container door engagement device configured to operably couple to a latch on a container door wherein the shaft member includes a first section, a second section and a third section contiguously formed.

An additional object of the present invention is to provide a tool configured to be operably coupled to a latch on a container door wherein the shaft member includes a plurality of weight reducing apertures.

Yet a further object of the present invention is to provide a container door engagement device configured to operably couple to a latch on a container door wherein an embodiment of the present invention includes a latch engagement member that is movable between a forty-five to one hundred and eighty degree angle with respect to the first end of the shaft member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention; and

FIG. 2 is a top view of the present invention; and

FIG. 3 is a perspective view of the present invention operably coupled with an exemplary door latch.

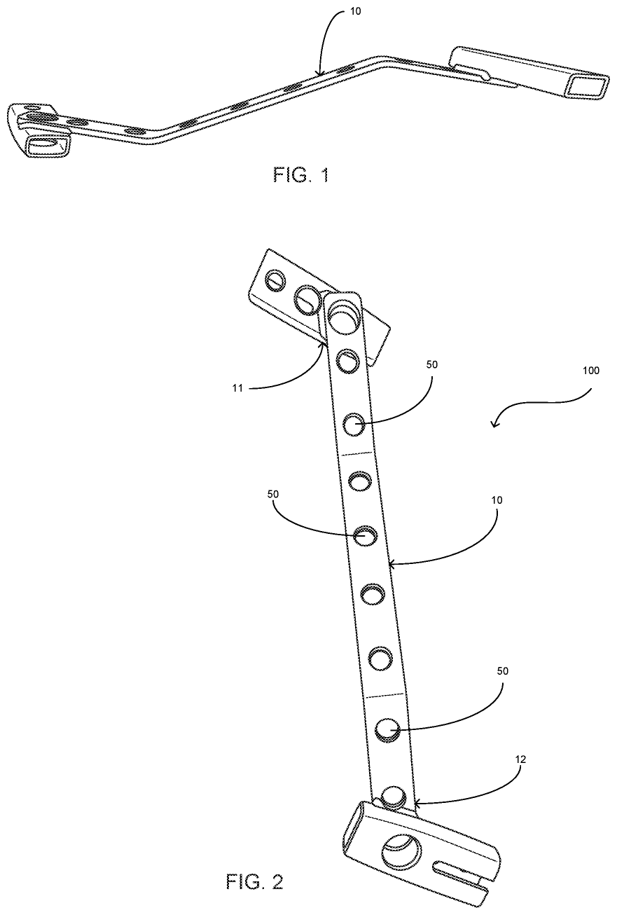

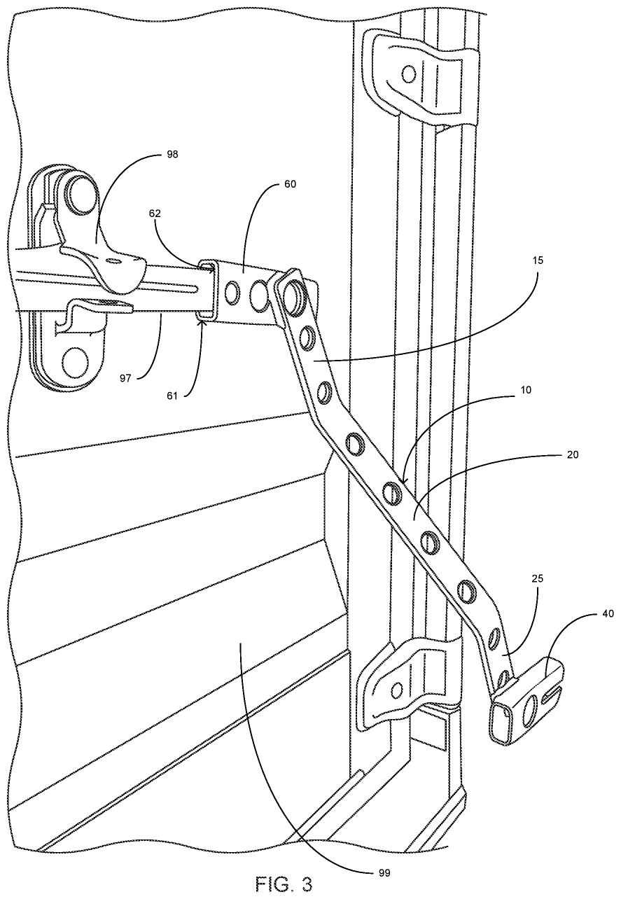

### DETAILED DESCRIPTION

Referring now to the drawings submitted herewith, wherein various elements depicted therein are not necessarily drawn to scale and wherein through the views and figures like elements are referenced with identical reference numerals, there is illustrated a container door engagement device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the container door engagement device 100 is manufactured from a suitable durable rigid material such as but not limited to metal. It should be understood within the scope of the present invention that the container door engagement device 100 could be provided in different sizes wherein the shaft member 10 is provided in alternate lengths. The container door engagement device 100 includes a shaft member 10 wherein the shaft member 10 includes a first end 11 and a second end 12. The shaft member 10 includes a first section 15, a second section 20 and a third section 25. The second section 20 is intermediate the first section 15 and third section 25. The first section 15 is angularly oriented with the second section 25 wherein the first section 15 is generally parallel with the exemplary door 99 during use of the container door engagement device 100. The second section 20 contiguously formed with the first section 15 is angularly oriented with the first section 15 such that the second section 20 extends away from exemplary door 99 during use of the container door engagement device 100. Third section 25 is contiguously formed with the second section 20 distal to the first section 15. The third section 25 of the shaft member 10 is angularly oriented with the second section 20 so as to be in generally planar alignment with the first section 15 and as such be generally parallel with exemplary door 99. The aforementioned configuration of the container door engagement device 100 provides a location of the handle member 40 that is placed away from the exemplary door 99 in order to place a user of the container door engagement device 100 in a more desirable position to operate latch 98. While a specific construction of the shaft member 10 is disclosed herein, it is contemplated within the scope of the present invention that the shaft member 10 could be constructed in alternate manners and achieve the objective discussed herein.

The handle member 40 is secured to the second end 25 of the shaft member 10 utilizing suitable durable techniques. The handle member 40 is manufactured from a rigid material such as but not limited to metal and extends outward from the third section 25. The handle member 40 is secured to the second end 12 of the shaft member 10 such that subsequent operable coupling of the container door engagement device 100 to the latch 98 the handle member 40 is generally parallel therewith. This orientation provides effective transfer of leverage for the container door engagement device 100 in order to facilitate operation of the latch 98. The length of the shaft member 10 is such that the handle member 40 is placed generally in the middle area and adjacent to the torso of the user of the container door engagement device 100. The shaft member 10 includes a plurality of weight reducing apertures 50. The weight reducing apertures 50 function to reduce the weight of the shaft member 10 without compromise of the structural integrity thereof. While the weight reducing apertures 50 are annular in shape in the drawings submitted herewith, it should be understood within the scope of the present invention that the weight reducing aperture 50 could be provided in alternate shapes and sizes. Furthermore, it is contemplated within the scope of the present invention that the shaft member 10 could have formed therein alternate quantities of weight reducing apertures 50.

The container door engagement device 100 includes a latch engagement member 60 secured to the first end 11 of the shaft member 10. The latch engagement member 60 is secured to the first end 11 at an angle between forty-five and one hundred and eighty degrees with respect thereto. The orientation of the latch engagement member 60 is such that the latch engagement member 60 is generally parallel with the handle member 40. The latch engagement member 60 is rectangular in shape having an opening 61 providing access to the interior volume 62 of the latch engagement member 60. The latch engagement member 60 is configured to have a portion of the handle 97 of the latch 98 inserted through the opening 61 into the interior volume 62 in order to operably couple the latch engagement member 60 with the handle 97 in order to provide operation of the latch 98. The latch engagement member 60 is frictionally coupled with the handle 97 in order to maintain engagement therewith. It is contemplated within the scope of the present invention that the latch engagement member 60 could additionally employ a mechanical element to maintain operable coupling with the handle 97. Furthermore, it is contemplated within the scope of the present invention that the latch engagement member 60 could be movably coupled to the first end 11 of the shaft member 10 and adjusted within the aforementioned range of forty-five to one hundred and eighty degrees.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A container door engagement device that is configured to be operably coupled to a latch operating a container door wherein the container door engagement device comprises:
a shaft member, said shaft member having a first end and a second end, said shaft member being elongated in shape;
a handle member, said handle member being secured to said second end of said shaft member;
a latch engagement member, said latch engagement member having an opening, said opening of said latch engagement member providing access to an interior volume of said latch engagement member, said interior volume of said latch engagement member configured to have a portion of a handle of the latch inserted thereinto; and
wherein the handle member is positioned so as to be parallel with the handle of the latch subsequent operable coupling of the container door engagement device with the latch.

2. The container door engagement device configured to be operably coupled to the latch operating a container door as recited in claim 1, wherein said shaft member includes a first section, a second section and a third section contiguously formed, said first section having the latch engagement member secured thereto.

3. The container door engagement device configured to be operably coupled to the latch operating a container door as recited in claim 2, wherein said second section of said shaft member is intermediate said first section and said third section.

4. The container door engagement device configured to be operably coupled to the latch operating a container door as recited in claim 3, wherein said first section and said third section are parallel with the door of the container.

5. The container door engagement device configured to be operably coupled to the latch operating a container door as recited in claim 4, wherein said second section of said shaft member is angularly oriented away from the door of the container.

6. The container door engagement device configured to be operably coupled to the latch operating a container door as recited in claim 5, wherein said shaft member further includes a plurality of weight reducing apertures, said weight reducing apertures being bored through said shaft member, said weight reducing apertures being intermediate said first end and said second end of said shaft member.

7. The container door engagement device configured to be operably coupled to the latch operating a container door as recited in claim 6, wherein said latch engagement member is oriented with respect to said first end at an angle between forty-five and one hundred and eighty degrees.

8. A container door engagement device that is configured to be operably coupled to a latch operating a container door in order to facilitate opening and closing of the container door wherein the container door engagement device comprises:
a shaft member, said shaft member having a first end and a second end, said shaft member being elongated in shape, said shaft member including a first section, a second section and a third section contiguously formed, wherein said second section of said shaft member is intermediate said first section and said third section, wherein said first section and said third section are parallel with the door of the container;
a handle member, said handle member being secured to said second end of said shaft member;
a latch engagement member, said latch engagement member having an opening, said opening of said latch engagement member providing access to an interior volume of said latch engagement member, said interior volume of said latch engagement member configured to have a portion of a handle of the latch inserted thereinto, wherein said latch engagement member is oriented with respect to said first end at an angle between forty-five and one hundred and eighty degrees; and
wherein the handle member is positioned so as to be parallel with the handle of the latch subsequent operable coupling of the container door engagement device with the latch.

9. The container door engagement device configured to be operably coupled to the latch operating the container door in order to facilitate opening and closing of the container door as recited in claim 8, wherein said shaft member further includes a plurality of weight reducing apertures, said weight reducing apertures being bored through said shaft member, said weight reducing apertures being intermediate said first end and said second end of said shaft member.

10. The container door engagement device configured to be operably coupled to the latch operating the container door in order to facilitate opening and closing of the container door as recited in claim 9, wherein said second section of said shaft member is angularly oriented away from the door of the container.
